(19) United States
(12) Patent Application Publication
(10) Pub. No.: US 2009/0293967 A1
(43) Pub. Date: Dec. 3, 2009

(54) VALVE ARRANGEMENT

(76) Inventor: Thor Frolich Braathen, Eggedal (NO)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/295,987

(22) PCT Filed: Dec. 5, 2006
(86) PCT No.: PCT/NO2006/000461

§ 371 Date: Aug. 18, 2009

(30) Foreign Application Priority Data
Apr. 6, 2006 (NO) 20061573

(51) Int. Cl. F16K 11/00

(52) U.S. Cl. 137/605

(57) ABSTRACT

A valve arrangement for a water heater, including a connection for cold water to the valve arrangement, a connection for cold water to the water heater, a connection for hot water from the water heater, a connection for temperature-controlled hot water from the valve arrangement, and a main channel for the valve arrangement that has a center axis along which there is arranged a plurality of components, at least a thermostatic mixing valve, integrated into the valve arrangement, and which connections are arranged at an angle, preferably perpendicular, to the centre axis of the main channel, with a center for the connection offset relative to the centre axis of the main channel, a rod-shaped temperature sensor of a PT valve for attachment to the valve arrangement being able to extend though the connection and into the water heater without interfering with the plurality of components integrated into the main channel.

### FIELD OF THE INVENTION

The present invention relates to a valve arrangement comprising, or adapted for the mounting of, a pressure and temperature relief valve (referred to hereafter as a PT valve), and which valve arrangement is adapted for connection to a water heater. More specifically, the invention relates to a valve arrangement as disclosed in the preamble of claim 1.

### BACKGROUND

In Great Britain and the USA it is a requirement that there should be a PT valve located either at the top of a water heater or on the side of the upper half thereof, a separate connection being used for the PT valve. In Great Britain, an expansion relief valve which relieves the increase in pressure on expansion of the water as a result of an increase in water temperature is used in addition. The opening pressure for the expansion relief valve is usually 8 bar. In addition, an expansion tank may be used that is large enough to receive 4% of the water volume in the water heater so as not to subject the expansion relief valve to loading, as the water volume increases by 4% on heating up from 10 to 80° C. Separate connections are used for both the expansion relief valve and the expansion tank and for the cold water (CW) and hot water (HW) connections. All told, this makes, according to the state of the art, five connections that must be welded or in some other way affixed to the water heater tank. This solution is therefore complex, costly, bulky and unaesthetic, and there is a higher risk of water leakages at the many connection points. A water supply pipe for cold water welded to the water heater, and which extends down into the water heater tank, represents a further disadvantage as the water supply pipe cannot easily be replaced or cleaned of lime scale build-up.

### SUMMARY

To remedy or eliminate the aforementioned disadvantages, according to the invention, there is provided a valve arrangement as disclosed herein.

### BRIEF DESCRIPTION OF THE DRAWINGS

In the following, advantageous embodiments of the invention are described with reference to the accompanying drawings and the attached claims, wherein:

FIG. 1a is a partially cut-away side perspective view of a first embodiment of a valve arrangement according to the invention;

FIG. 1b is a partially cut-away top view of the valve arrangement in FIG. 1a;

FIG. 2a is a partially cut-away side perspective view of a second embodiment of a valve arrangement according to the invention; and

FIG. 2b is a partially cut-away top view of the valve arrangement in FIG. 2a.

### DETAILED DESCRIPTION OF THE PREFERRED EMBODIMENTS

In the figures, the same or similar components are not necessarily indicated by the same reference numerals. Furthermore, directional designations such as “upper”, “lower” etc. are given with reference to the valve arrangement as shown in the drawings, and do not necessarily correspond to the position of a connected valve arrangement according to the invention. The object of the invention is primarily to provide a compact valve arrangement with a reduced number of connection points (one or two), and as the function and the structure of the various components included in the valve arrangement are previously known (see, for example, the Applicant's international publication WO 2005/078359), they are merely described and referred to insofar as is relevant to the invention. With regard to the invention, it should also be mentioned that in accordance with the state of the art, the valve housing is advantageously cast in brass, and that for rational production, there are drilled holes or bores which form channels in the valve housing advantageously perpendicular and offset in relation to each other to form an opening or fluid communication between two or more channels.

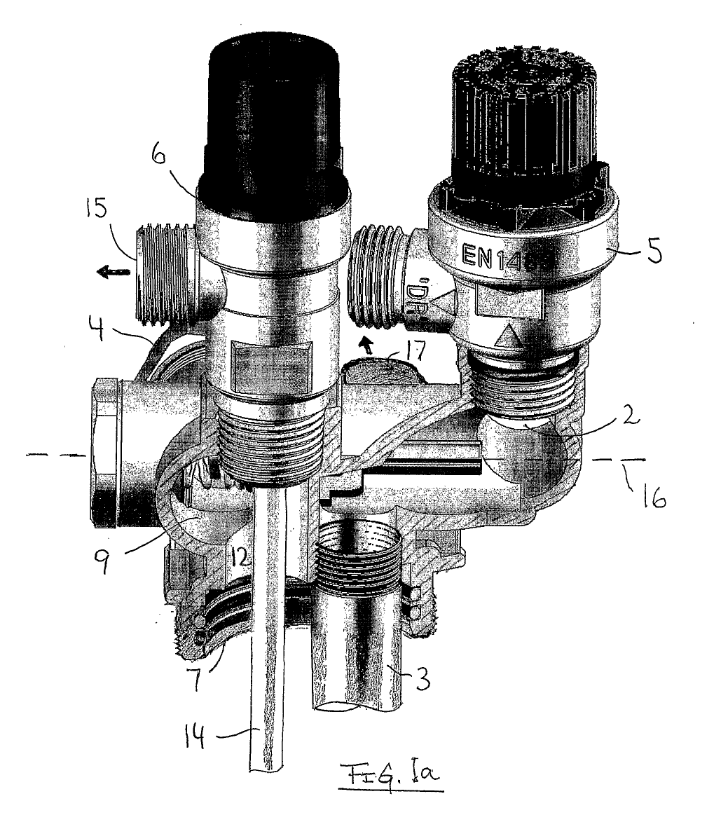

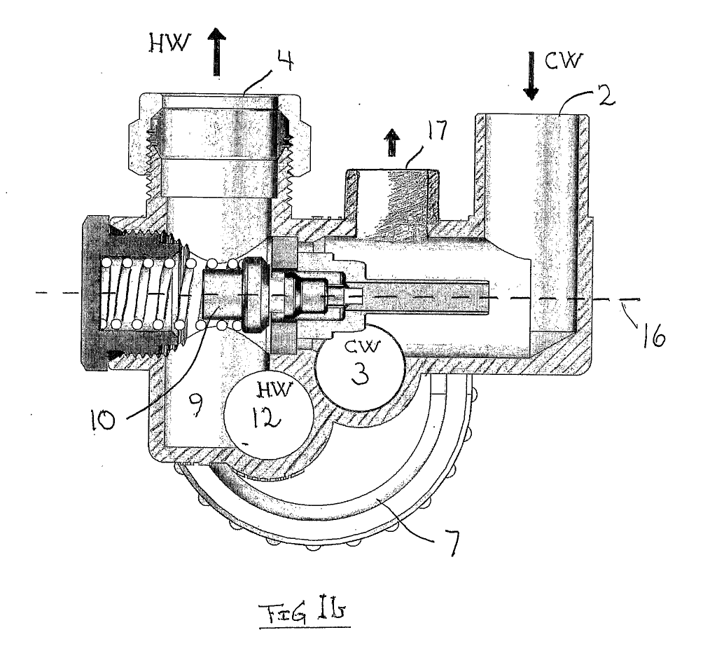

With reference to FIGS. 1a and 1b, there is shown a first embodiment of the valve arrangement according to the invention, having a single connection 7 to a (non-illustrated) water heater tank, which connection 7 advantageously is a 1½″ connection. The valve arrangement further comprises a connection 2 for cold water (CW), a PT valve 6, an expansion relief valve 5, a connection 4 for hot water (HW) from the water heater, a connection 17 for a (non-illustrated) expansion tank and a connection 15 for overflow to a drain via a hose (not shown).

The PT valve 6 has an integrated rod-shaped temperature sensor 14 for lowering into the water heater tank so that the temperature in the water heater tank can be sensed by the PT valve 6. The PT valve 6 opens advantageously at a water temperature of more than 95° C., and lets water out through the overflow connection 15.

Cold water (CW) enters the valve arrangement through the connection 2, and is admitted to the water heater tank through a pipe 3. As the diameter of the single connection 7 is quite large (1½″), the pipe 3 can pass into a funnel-shaped nozzle (not shown) having an orifice diameter almost as large as the diameter of the connection 7, and through which nozzle the cold water is dispersed in the water heater tank. On mounting and demounting the valve arrangement, the pipe 3 with the funnel-shaped nozzle can be passed through the connection 7, the nozzle extending further into the water heater tank than the temperature sensor 14 running parallel thereto, and as the diameter of the orifice of the nozzle is slightly smaller than the diameter of the connection 7. The non-illustrated nozzle provides a slower release of cold water into the water heater tank, and a nozzle of this kind therefore has a favourable effect for the discharge of hot water from the water heater. The pipe 3 and nozzle can easily be replaced or descaled since the pipe 3, as shown in FIG. 1a, is threadedly fastened to the valve arrangement instead of being welded to the connection on the tank.

The hot water (HW) exiting through the connection 4 is temperature-controlled as the valve arrangement advantageously includes a thermostatic mixing valve with a temperature sensor 10, known from the aforementioned WO publication.

Hot water at a temperature of about 70° C. passes from the water heater tank up through the connection 7, into a channel 12 and a channel 9 past the temperature sensor 10, where the water temperature is controlled to a temperature below scalding temperature, (for example, max 60° C.) in that the temperature sensor 10 admits cold water through an opening 11 in which the temperature sensor 10 is arranged. At a temperature of more than 95° C. in the water heater tank, the PT valve 6 opens and evacuates hot water through the overflow 15 via the channel 12.

The bore which forms the channel 12 intersects a bore which forms an extension of the connection 4, so that fluid communication is obtained between the two as explained above, and the PT valve 6 is threadedly connected at an upper end of the channel 12. The integrated temperature sensor 14 of the PT valve 6 runs down through the channel 12 and into the water heater tank.

The arrangement of the PT valve temperature sensor 14, the hot water outlet from the water heater through the channel 12 and the cold water inlet to the water heater through the pipe 3 using just one connection 7 is made possible here in that a centre of the connection 7 is offset in relation to the centre line 16 of a substantially perpendicularly arranged main channel for the valve arrangement through which the cold water passes before it is fed into the pipe 3, and along which centre line the integrated components of the valve arrangement—in this first embodiment just a thermostatic mixing valve—advantageously are arranged. In order to make possible a single connection 7, as shown in FIGS. 1a and 1b the channel 9 is also arranged perpendicular to the main channel and has a centre line that intersects the centre line 16, and which channel 9 extends essentially perpendicular to and offset in relation to the channel 12, the channel 12 and the pipe 3 being essentially parallel and adjacent. Thus, this prevents, among other things, that the channel 12 and the temperature sensor 14 arranged therein interfere with the main channel and the components integrated in the main channel.

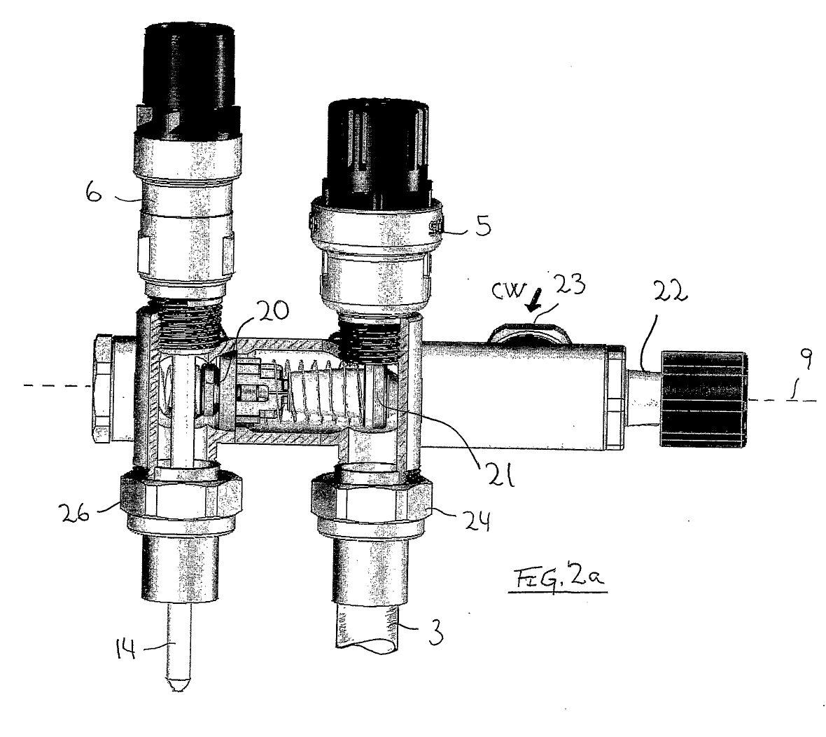

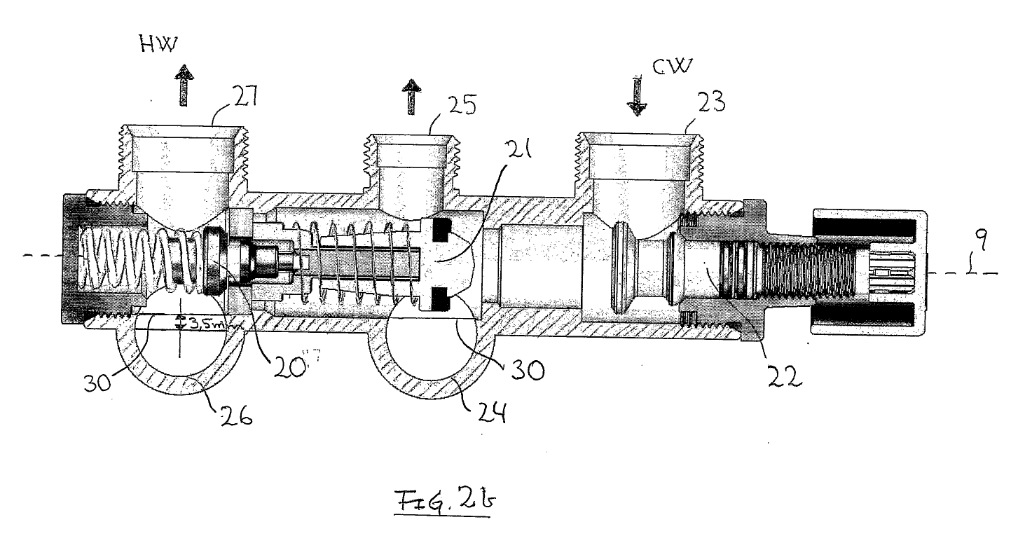

FIGS. 2a and 2b show a second embodiment of the valve arrangement according to the invention with two connections 24, 26 to a (non-illustrated) water heater tank. The connection 24 is for the supply of cold water to the water heater tank through a pipe 3 and the connection 26 is for withdrawal of hot water from the water heater tank and the lowering of a PT valve 6 temperature sensor 14 into the water heater tank.

The valve arrangement shown in FIGS. 2a and 2b further includes an expansion relief valve 5, a connection 23 for cold water (CW), a connection 27 for temperature-controlled hot water (HW), and a connection 25 for a (non-illustrated) expansion tank. With reference to the aforementioned WO publication, the valve arrangement also advantageously comprises a stopcock 22, a non-return valve 21 and a thermostatic mixing valve equipped with a temperature sensor 20 integrally arranged along a centre line 9 of the main channel of the valve arrangement.

The mode of operation of the valve arrangement when water is drawn is described briefly as follows:

Cold water (CW) passes in through the connection 23, through the open stopcock 22 and into the water heater tank through connection 24. At a temperature for water exiting the water heater through the connection 26 of, for example, 70° C., about 20% of the inflowing cold water passes through the mixing valve so that the hot water (HW) exiting from the connection 27 has a temperature of 59° C., the function of the mixing valve being essentially the same in the first and the second embodiment. About 80% of the cold water thus passes down to the bottom of the water heater through the connection 24 and a pipe 3 threadedly connected to the connection 24. The cold water that flows into the water heater tank forces hot water out of the tank through the connection 26, whereupon it is temperature-controlled by the mixing valve and passes out through the connection 27 to a water tap.

The mode of operation of the valve arrangement without drawing water is briefly described as follows:

The valve arrangement and the water heater tank are under pressure corresponding to the pressure of the cold water passing in through the connection 23. When the water in the water heater is heated from 10 to 80° C., there is also a 4% volume increase or expansion of the water. To prevent the increased water volume from passing back through the connection 23, and thus being able to be mixed with and contaminate the water in the public pipeline network connected to the connection 23, the non-return valve 21 closes against its seat in response to the pressure difference in the valve arrangement as a result of the heating of the water. Expansion water must then either pass into a non-illustrated expansion tank through the connection 25, or alternatively the expansion relief valve 5 directs the expansion water to the drain by opening at a pressure of, for example, 8 bar. If all other safety means fail, including a (non-illustrated) electric thermostat in the water heater, the PT valve 6 starts to function so that at a pressure of more than 10 bar and/or a temperature of more than 95° C., the water passes out to the drain via the PT valve 6.

In the second embodiment of the valve arrangement according to the invention, two connections 24, 26 to the water heater tank are made possible in that the connection 26, through the centre of which the temperature sensor 14 of the PT valve 6 extends coaxially, is offset in relation to the centre line 9 of the main channel of the valve arrangement. This solution prevents the temperature sensor 14 from interfering with the main channel and the integrated components of the main channel. With a diameter of the temperature sensor 14 of 7 mm, the centre of the channel or bore for the connection 26 is advantageously offset 3.5 mm in relation to a cylindrical inner wall 30 of the main channel, as shown in FIG. 2b. This offset results advantageously in sufficient flow cross-section, or sufficient fluid communication, between the two intersecting channels. To ensure correspondingly large fluid communication between the channel or bore for the connection 24 and the main channel, the channel for the connection 24 is advantageously offset the same distance (that is to say 3.5 mm) in relation to the inner wall 30 of the main channel.

1. A valve arrangement for a water heater, including a connection for cold water to the valve arrangement, a connection for cold water to the water heater, a connection for hot water from the water heater, a connection for temperature-controlled hot water from the valve arrangement, and a main channel for the valve arrangement, which main channel has a centre axis along which there is arranged a plurality of components, at least a thermostatic mixing valve, integrated into the valve arrangement, and which connections are arranged at an angle, preferably perpendicular, to the centre axis of the main channel, characterised in that a centre for the connection is offset in relation to the centre axis of the main channel, a rod-shaped temperature sensor of a PT valve for attachment to the valve arrangement being able to extend though the connection and into the water heater without interfering with said plurality of components integrated into the main channel.

2. A valve arrangement according to claim 1, characterised in that there is provided just one connection to the water heater, a pipe for supply of cold water being passed through the connections.

3. A valve arrangement according to claim 2, characterised in that the pipe passes into a funnel-shaped nozzle with an orifice diameter smaller than the diameter of the connection, the nozzle extending further into the water heater than the temperature sensor.

4. A valve arrangement according to claim 2, characterised in that the pipe is threadedly fastened to the valve arrangement.

5. A valve arrangement according to claim 1, characterised in that there are provided two connections to the water heater, the pipe for the supply of cold water being threadedly fastened to the connection.

6. A valve arrangement according to claim 5, characterised in that the centre of the connections is offset the same distance in relation to an inner wall of the main channel.

7. A valve arrangement according to claim 6, characterised in that the centre of the connections is offset 3.5 mm relative to the inner wall of the main channel.

8. A valve arrangement according to claim 1, characterised in that the connection is a 1½″ connection.

9. A valve arrangement according to claim 5, characterised in that the connections are 22 mm connections.

10. A valve arrangement according to claim 9, characterised in that attached to the valve arrangement is an expansion relief valve.
